(19) United States
(12) Patent Application Publication
(10) Pub. No.: US 2002/0116639 A1
(43) Pub. Date: Aug. 22, 2002

(54) Method and apparatus for providing a business service for the detection, notification, and elimination of computer viruses

(75) Inventors: Thomas E. Chefalas, Somers, NY (US); Steven J. Mastrianni, Unionville, CT (US); Ajay Mohindra, Yorktown Heights, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/789,867

(22) Filed: Feb. 21, 2001

(51) Int. Cl. G06F 11/30

(52) U.S. Cl. 713/201

(57) ABSTRACT

A method, apparatus, and computer implemented instructions for handling a virus in a network data processing system. A client data processing system monitors for the virus. In response to detecting the virus, the client data processing system sends notification of a presence of the virus on the data processing system to a server, wherein the notification includes an identification of an action taken in response to detecting the virus. Further, the client data processing system may take actions to eliminate or quarantine the virus. In a server data processing system, a notification of a presence of a virus on a client data processing system is received through a communications link. The communication with the client data processing system through the communications link is severed in response to receiving the notification. Virus removal processes may be executed on the server data processing system. Alternatively or additionally, the server data processing system may execute an action based on a business policy in response to receiving the notification.

### BACKGROUND OF THE INVENTION

1. Technical Field

The present invention provides an improved data processing system and in particular, a method, apparatus, and computer implemented instructions for handling viruses. Still more particularly, the present invention provides a method, apparatus, and computer implemented instructions for a business service for the detection, notification, and elimination of computer viruses.

2. Description of Related Art

A virus is software used to infect a computer. After the virus code is written, it is buried within an existing program. Once that program is executed, the virus code is activated and attaches copies of itself to other programs in the system. Infected programs copy the virus to other programs. The effect of the virus may be a simple prank that pops up a message on screen out of the blue, or the virus may destroy programs and data right away or on a certain date. The virus can lie dormant and do damage once a year. For example, the Michelangelo virus contaminates the machine on Michelangelo's birthday. The detection of computer viruses is a well-understood technology.

Several large companies are involved in the business of virus detection and elimination, including Symantec Corporation, McAfee.com Corporation, and Intel Network Systems, Inc. Some of these products, specifically Symantec Corporation, offer a corporate version of their software for administration and use on internal corporate networks, or intranets. In this configuration, the virus detection client software is installed on each client computer and the virus checker is run at specified intervals to check for viruses on that client machine. If a virus is detected, the client program informs the user that a virus has been detected and takes automatic action or prompts the user for an action depending on the administrative settings.

When a virus is detected, the user at the client computer is instructed to either quarantine the infected file or files, remove them from use on the current system, or automatically repair the infected files. Once the files have been either been quarantined or repaired, the user can begin to use the system once again. The user may then be instructed to contact the system administrator or information technology (IT) department to alert them of the virus.

The main weakness of this strategy is that significant damage to the system may already have occurred before the virus is detected. Some viruses are capable of destroying hundreds or even thousands of files before they are even detected. In the worst case, by the time the client machine has detected the virus, the virus may have cloned itself on another client machine on the network or on a network share. Note that a network share is any shared resource that may be shared or used by different clients. For example, a network share may include a drive, a file, a printer, or a display device. Network shares are managed and exported by a network server. From the network share, the virus can begin deleting files and cloning itself onto other client systems. Finding the source of the virus and removing any trace of it on the network usually requires that the network server be shut down, the network shares removed, and each client machine disinfected while disconnected from the network.

Regardless, the detection of the virus occurs at a local level on the infected machine. Since the virus is detected on a particular machine, the virus disinfecting program disinfects that particular client machine but does not go beyond the scope of the current machine.

In the case of viruses that replicate onto other systems, it is likely that the virus had already replicated before the detection occurred. In this case, disinfecting the current system is not very effective since the virus could quickly replicate itself back on the current system. In order to effectively disinfect all the networked machines, each machine must be disconnected from the network, disinfected, and then placed back on the network only after each networked client machine has been checked and disinfected.

For a large network of machines, this procedure can be a very lengthy and difficult procedure for novice users or administrators to implement. Although most corporations with large networks have policies against downloading potentially harmful content, i.e., content that could contain viruses, smaller companies with less experienced staff are more susceptible and liable to download potentially harmful content.

Therefore, it would be advantageous to have an improved method and apparatus for providing a service for the detection, notification, and elimination of computer viruses.

### SUMMARY OF THE INVENTION

The proposed invention eliminates the weakness of the current approaches to handle virus detection and elimination by providing a business service for automatic detection, notification and elimination of viruses for a large network of machines. The proposed invention does not require manual intervention and can act quickly and effectively to prevent viruses from spreading across the network of machines. The present invention provides a method, apparatus, and computer implemented instructions for handling a virus in a network data processing system. A software subsystem known as a virus scanner and notifier (VSN), residing on a client data processing system monitors for viruses. In response to detecting a virus infection, the VSN at the client data processing system sends notification of a presence of the virus on the data processing system to a software module known as the virus scanner controller (VSC) residing at a server, wherein the notification includes an identification of an action taken in response to detecting the virus. Further, the VSN at the client data processing system may take actions to eliminate or quarantine the virus. In a server data processing system, a notification of a presence of a virus on a client data processing system is received through a communications link. The communication with the client data processing system through the communications link is severed in response to receiving the notification. Virus removal processes may be executed on the server data processing system. Alternatively or additionally, the VSC module at the server data processing system may execute an action based on a business policy in response to receiving the notification.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in accordance with a preferred embodiment of the present invention;

FIG. 2, is a block diagram of a data processing system that may be implemented as a server in accordance with a preferred embodiment of the present invention;

FIG. 3 is a block diagram illustrating a data processing system in which the present invention may be implemented;

FIGS. 4A and 4B are diagrams illustrating business events in accordance with a preferred embodiment of the present invention;

FIGS. 5A and 5B are illustrations of policies for taking action in response to notification of a virus in accordance with a preferred embodiment of the present invention;

FIG. 6 is a flowchart of a process used for handling viruses in a client in accordance with a preferred embodiment of the present invention;

FIG. 7 is a flowchart of a process used for handling a virus notification from a business event received at a server in accordance with a preferred embodiment of the present invention; and

FIG. 8 is a flowchart of a process used for handling the notification of a virus based on a business policy in accordance with a preferred embodiment of the present invention.

### DETAILED DESCRIPTION OF THE PREFERRED EMBODIMENT

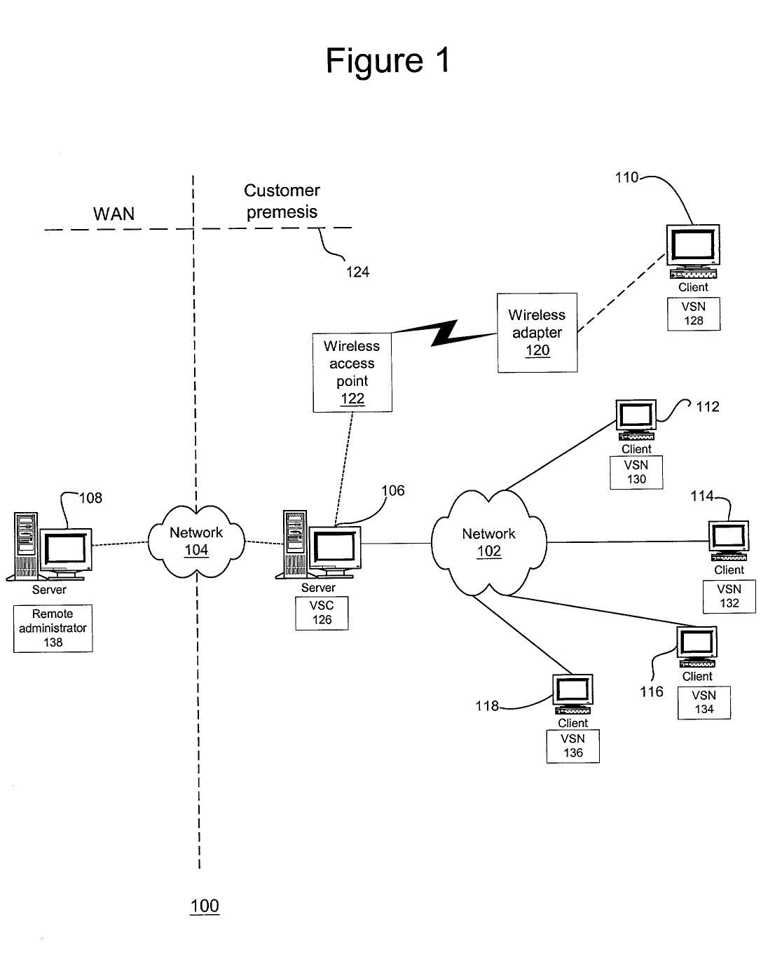

With reference now to the figures, FIG. 1 depicts a pictorial representation of a network data processing system in accordance with a preferred embodiment of the present invention. Network data processing system 100 is a network of computers in which the present invention may be implemented. Network data processing system 100 contains a network 102 and a network 104, which provide a medium of communications links between various devices and computers connected together within network data processing system 100. Network 102 and network 104 may include connections, such as wire, wireless communication links, or fiber optic cables.

In the depicted examples, server 106 is connected to network 102 and network 104. Server 108 is connected to network 104. Clients 110, 112, 114, 116, and 118 are clients to server 106 in these examples and use network shares managed and exported by the server 108. Clients 112-118 communicate with server 106 through network 102, which is a local area network (LAN) in this example. Client 110 employs a wireless communication link through wireless adapter 120 and wireless access point 122. As illustrated, server 106 and clients 110-118 are located at customer premises 124. In these examples, server 106 and client computers 110-118 include the appropriate software to enable communication between them, such as through a TCP/IP communication protocol. These systems may also include software applications for a user to manage routine management information tasks. These applications may include, for example, a web browser and a mail client. Server 108 is in a remote geographic location and connected to server 106 through network 104, which takes the form of a wide area network (WAN) in this example.

Of course network data processing system 100 may be implemented using a number of different types of networks in addition to and in place of those shown in FIG. 1. For example, a WAN, an intranet, or the Internet in place of a LAN may be used to implement network 102. FIG. 1 is intended an as example, and not as an architectural limitation for the present invention.

This present invention provides a method, apparatus, and computer implemented instructions for an automated solution for handling viruses. The mechanism of the present invention may be implemented through a set of software components and procedures that perform the difficult task of removing viruses without involving highly-skilled network administrators or technicians. This automated function can be provided in software installed on server 106 known as virus scanner controller (VSC) and clients 110-118 known as virus scanner and notifier (VSN).

In this example, VSC 126 is located on server 106. VSNs 128-136 are located on clients 110-118. Remote administrator 138 is located on server 108. The mechanism is deployed as a business service to users who register and subscribe for the service. These components form a system architecture of a preferred embodiment for providing virus detection, notification, and elimination as a business service.

A business service is a business model in which a software application is deployed to a customer as a service on a subscription-fee basis. Customers subscribe to the service and the service provider charges its customers a monthly rate, fixed or variable, for providing the service. The service provider is responsible for the equipment and infrastructure needed to provide and deliver the service. The service provider also maintains the service by providing periodic software updates, functional enhancements, and support for the service. Server 106 at the customer premises has a virus scanner and notifier module within VSC 126 to coordinate activity and receive events from the virus scanner and notifier module located at clients 110-118 on the network. Although a single server is illustrated, the mechanism of the present invention may be implemented using multiple servers.

If a virus is detected on a client, such as client 112, software agent, VSN 128, installed on the client 112 immediately quarantines the offending file and notifies VSC 126 at server 106 via network 104 that a virus has been detected. If the detected virus is the type of virus that can be replicated or cloned, VSC 126 at server 106 immediately severs the connection with client 112 and all other clients connected to the server. Further, VSC 126 at server 106 initiates the virus removal processes on clients 110-118. Server 106 also removes any network shares under its control. Then, VSC 126 at server 106 runs the anti-virus software on the server, removing and quarantine any infected files. Server 106 may then decide to shut down to protect itself and the network shares it controls.

If the network 102 contains a managed switch or managed router, the connections to clients 112-118 are disabled by using the management capabilities of the managed router or managed switch. For benign viruses, server 106 may optionally elect to simply log the virus detection event and continue normal operations.

If the mechanism of the present invention is being supplied as a business service, VSC 126 at server 106 immediately notifies the remote administrator by sending it a virus detected business event and also sending an e-mail message to the remote administrator with information about the type of virus detected, the name of the client it was detected on, and the steps taken to disinfect the system. In this example, the remote administrator is located at server 108. Further, other actions may be taken in place of or in addition to these actions. For example, VSC 126 at server 106 also may page a technician or initiate a phone call with a support technician. Upon receiving the notification at server 108, the administrator event routing system may in turn generate other business events, schedule an on-site service call or phone call to the customer, page a technician, or in extreme cases, even shut down the local server and/or the LAN.

VSC 126 at server 106 then begins a scan of its own memory and storage to make sure that it was not affected by the virus. Once complete, VSC 126 at server 106 re-enables the network hardware waits for each client to contact server 106 with a request to reconnect with the network shares. As each VSN at each client completes execution of virus removal processes, the VSNs 128-136 will notify VSC 126 at server 106 of this event. When all of clients 110-118 have been disinfected, server 106 will reestablish the network shares and trusted connections. Once the network shares are accessible, VSC 126 at server 106 sends a notification to VSNs 128-136 at clients 110-118 that the crisis is over and that they may once again access the network shares.

If the same type of virus occurs several times in a specified time interval, server 106 sends a priority business event to the remote network administrator at server 108. That event is acted upon by the business event routing mechanism on server 108. The rules defined on the remote administration computer may instruct server 106 to shut down to protect the rest of the network. In this case, server 108 sends a business event to the server 106, which will then sever all connections and remain disconnected until the connections are reinstated by a network administrator.

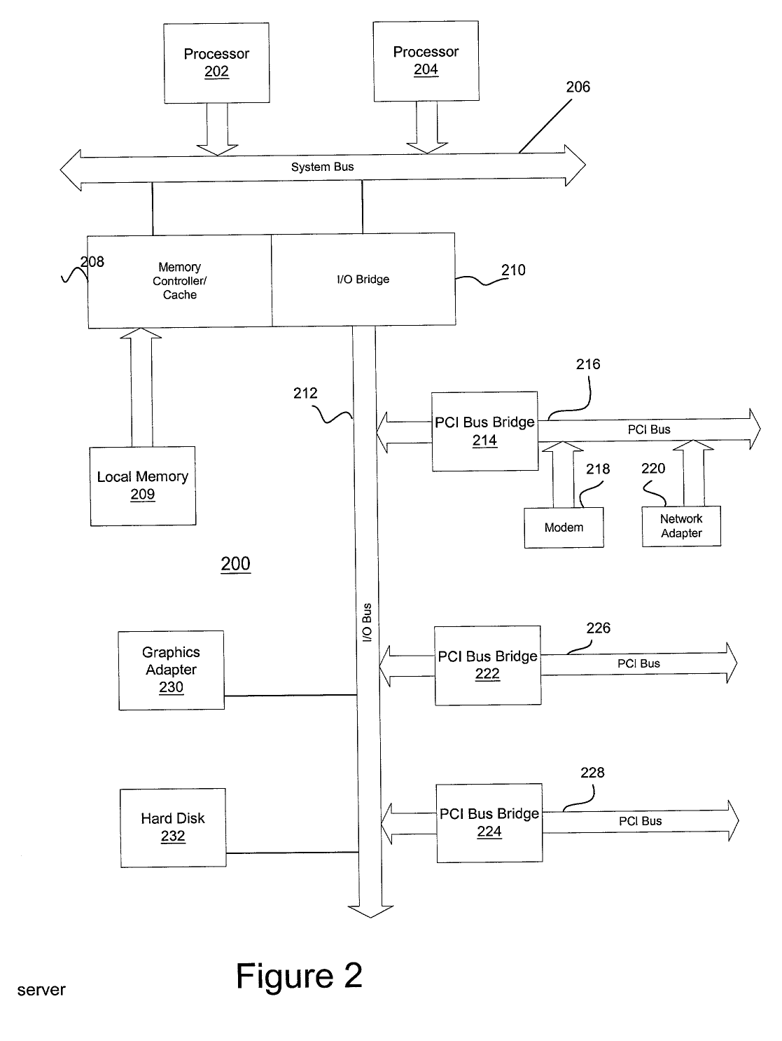

Referring to FIG. 2, a block diagram of a data processing system that may be implemented as a server, such as server 106 or server 108, in FIG. 1 is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

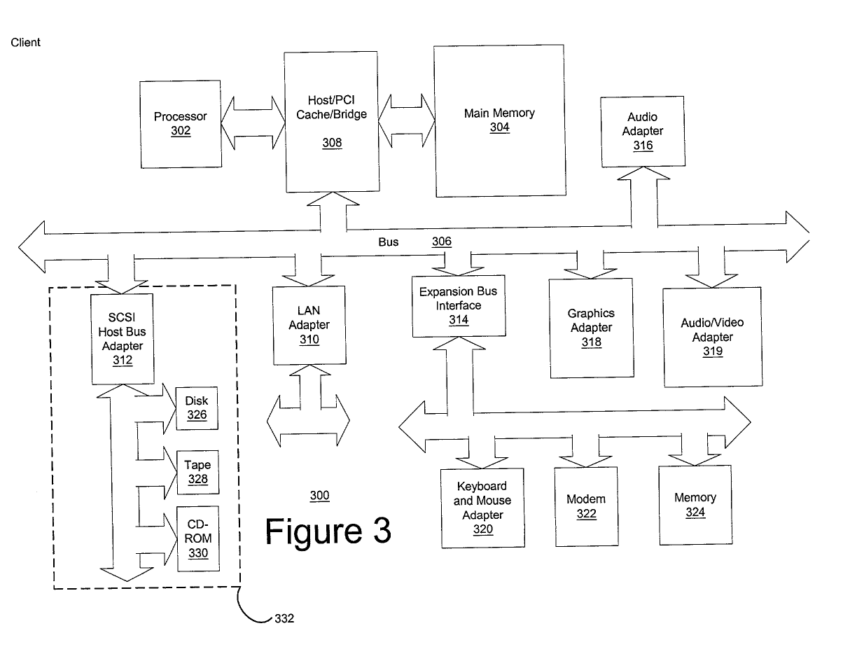

With reference now to FIG. 3, a block diagram illustrating a data processing system is depicted in which the present invention may be implemented. Data processing system 300 is an example of a client computer, such as client 112 in FIG. 1. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

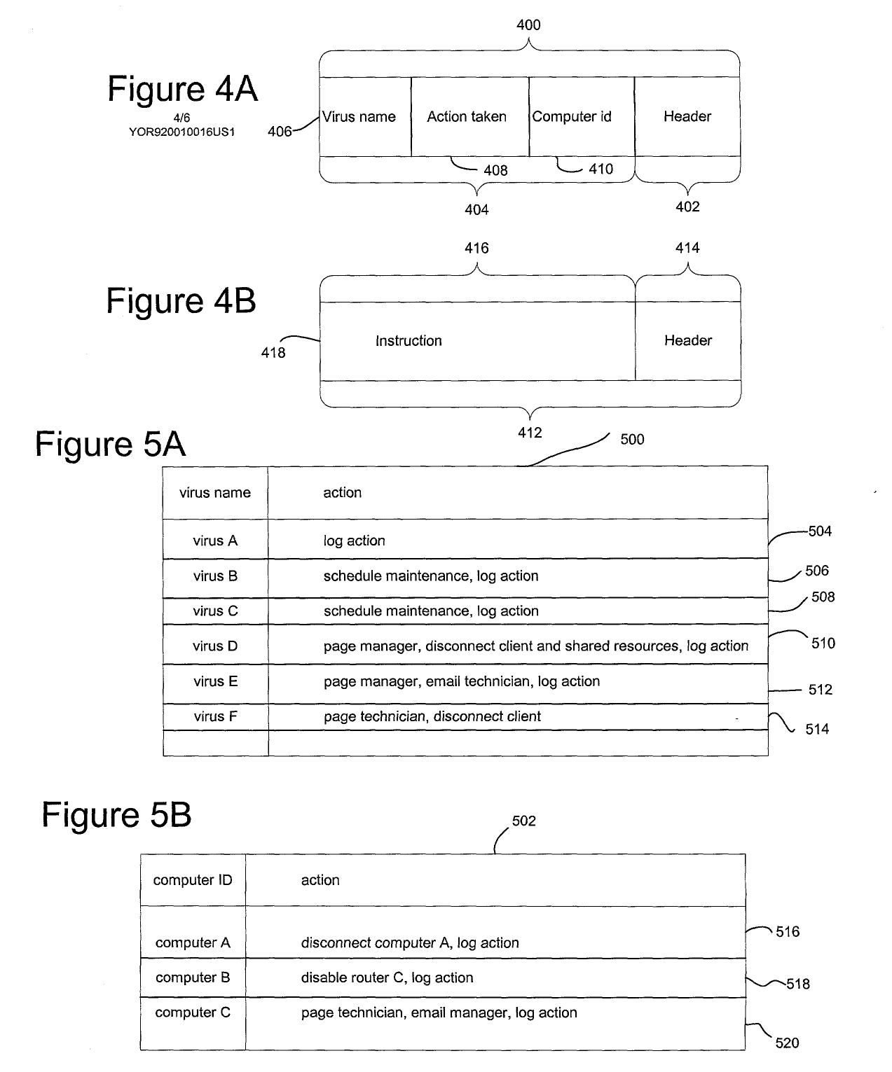

With reference now to FIGS. 4A and 4B, diagrams illustrating business events are depicted in accordance with a preferred embodiment of the present invention. In FIG. 4A, business event 400 may be an event sent from a VSN at the client to a VSC at the server, providing notification of an action taken on the client. Additionally, business event 400 may also be an event sent from a server, such as server 106 in FIG. 1 to a server containing an administrative or business process, such as server 108 in FIG. 1.

In this example, business event 400 takes the form of a data packet, which contains a header 402 and a payload 404. Header 402 contains information used to route business event 400. In this example, payload 404 includes the following fields, virus name 406, action taken 408, and computer ID 410. Virus name 406 contains the name of the virus detected on the client. Action 408 identifies actions, such as, for example, whether the virus was removed, whether the file was quarantined, or whether no action was taken. Computer ID 410 identifies the client from which business event 400 originates. Business event 400, as illustrated in only exemplary, and other information may be included or in place of the fields shown. For example, a day and date as to when the action was taken and damaged files, if any, are other information that may be placed within business event 400.

In FIG. 4B, business event 412 is an example of a business event sent from a server to a client or from one server to another server. Business event 412 takes the form of a data packet having a header 414 and a payload 416. In this example, payload 416 contains an instruction 418. If sent to a client from a server, the instruction may be, for example, to initiate a virus checking process. If sent from one server to another server, the instruction may be, for example, to shut down the server receiving business event 412.

Turning now to FIGS. 5A and 5B, illustrations of policies for taking action in response to notification of a virus are depicted in accordance with a preferred embodiment of the present invention. Policy 500 in FIG. 5A and policy 502 in FIG. 5B are examples of rules that may be used to implement business decisions as to how to handle the notification of the presence of a virus within a network data processing system. In the depicted examples, policy 500 provides for different actions based on the name of the virus, as illustrated in entries 504-514. The virus names are used as indexes into policy 500. For example, if virus A is present, entry 504 merely logs the action taken at the client. An occurrence of virus B or virus C results in the scheduling of maintenance of the client and logging of the client as shown in entries 506 and 508. The presence of virus D indexes to entry 510, which results in a manager being paged, the client and shared resources being disconnected, and the action taken at the client being logged. The occurrence of virus F results in a technician being paged and the client being disconnected as shown in entry 514.

In FIG. 5B, policy 502 identifies actions based on the identification of the client based on the computer ID. In entry 516 computer A is disconnected and the action taken at computer A is logged if the business event identifies the virus as being detected at computer A. If the business event originates from computer B, router C is disabled and the action taken at computer B is logged as illustrated in entry 518. If the business event is identified as originated from computer C, the action taken is to page a technician, email a manager, and log the action taken at computer C as shown in entry 520.

In FIG. 5A and FIG. 5B, policy 500 and policy 502 are illustrated as being implemented in tables. Such an illustration is exemplary. These policies may be implemented using other data structures, such as, for example, a relational database. Policy 500 and policy 502 are examples of policies that may be implemented in a business service. When notification of a virus is received, a decision as to what action is to be taken is generated based on these policies. Implemented as a business service, the actions may be initiated for the registered customer. For example, automatically paging a manager, a technician or scheduling a service are some actions that may be offered. Instructing the customer server to shut down or disconnect resources are examples of other actions that may be offered. These actions may or may not require processes to be located on the customer machines in offering the business service.

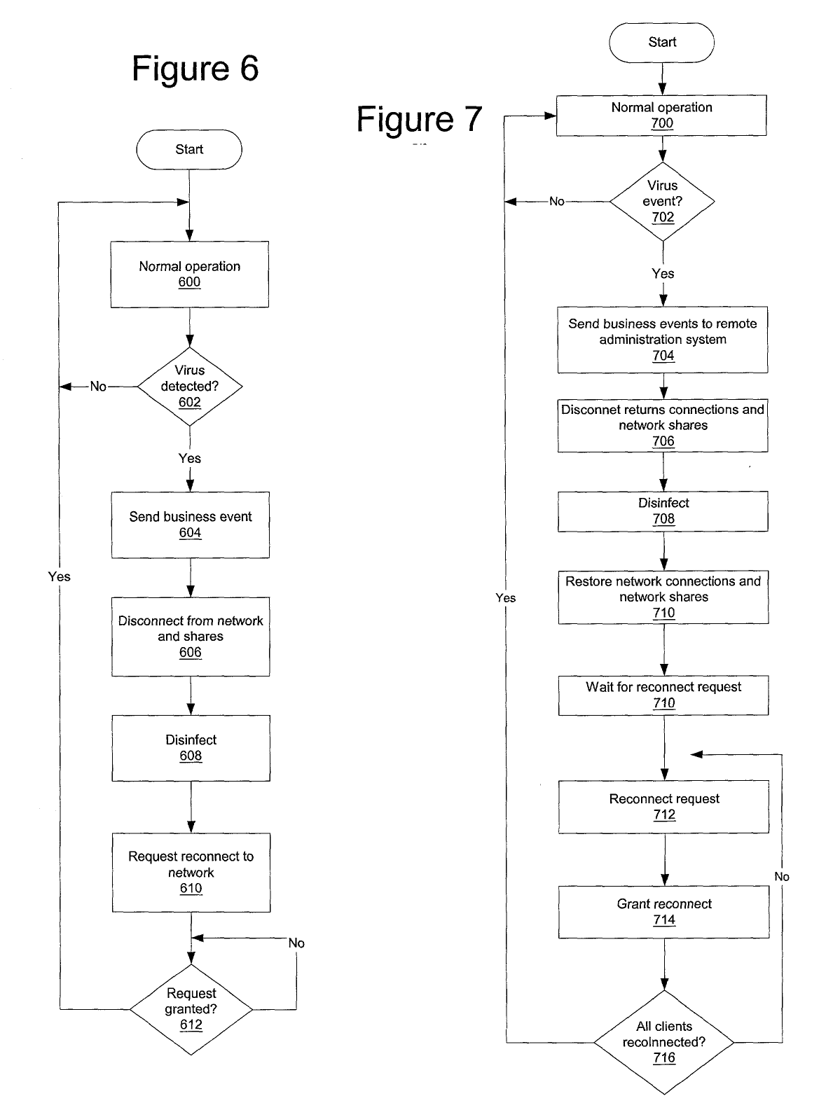

Turning next to FIG. 6, a flowchart of a process used for handling viruses in a client is depicted in accordance with a preferred embodiment of the present invention. The process illustrated in FIG. 6 may be implemented in a VSN at the client, such as client 112 in FIG. 1.

The process begins with normal operation occurring (step 600). These operations are the normal, everyday operations occurring at the client. After a period of time, a determination is made as to whether a virus has been detected (step 602). Step 602 may be implemented using known virus checking processes. If a virus has been detected, the VSN at the client sends business event providing a notification of the virus to a VSC at the server (step 604). This business event may be sent using business event 400 in FIG. 4. The event may also include the action that is to be taken at the client in handling the virus.

Then, the client disconnects from the network and network shares (step 606). The client is disinfected (step 608). In the depicted examples, disinfecting involved eliminating the virus and/or quarantining any affected files. After disinfecting, the client requests to reconnect to the network (step 610). If the request is granted (step 612) the process returns to step 600 as described above. If the request is not granted, the process returns to step 612 as described above.

Returning to step 602, if no virus has been detected, then the process returns to step 600 as described above. The processes illustrated in FIG. 6 are initiated automatically without requiring user intervention at the client.

With reference now to FIG. 7, a flowchart of a process used for handling a virus notification from a business event received at a server is depicted in accordance with a preferred embodiment of the present invention. The process in FIG. 7 may be implemented in a server, such as server 106 in FIG. 1.

The process begins with normal operation occurring on the server (step 700). A determination is then made as to whether a virus event has occurred (step 702). A virus event is detected by receiving a business event from a client containing a notification that a virus was detected on the client. If a virus event has been detected, the server sends business event to a remote administration system (step 704). The remote administration system may be, for example, server 108 in FIG. 1. Next, the remote connections and network shares are disconnected from the server (step 706). This step is used to prevent further spreading of the virus in case the virus has been sent to the server. The server is then disinfected (step 708). Then, the network connections and network shares are restored (step 710). Next, a determination is made as to whether the system waits for a reconnect request has been received (step 712). If a reconnect request has been received, the request is granted (step 714). Then, a determination is then made as to whether all of the clients have been reconnected (step 716). If all the clients have been reconnected, the process to step 700 as described above. Otherwise, the process returns to step 712 as described above.

With reference back to step 712, if a reconnect request is not received, the process proceeds to step 716 as described previously. Returning to step 702, if no virus event has occurred, the process returns to step 700 as described above.

FIG. 6 and FIG. 7, both the server and the client disconnect or sever connections to the network. Of course, such a step may be initiated in just the server or the client depending on the particular implementation.

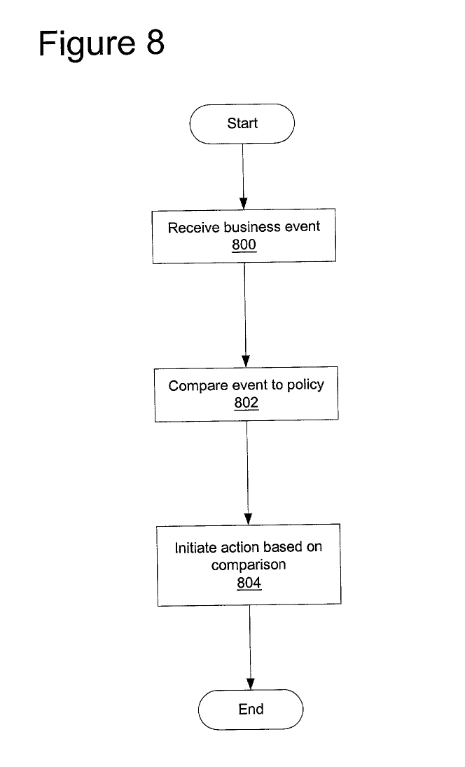

Turning next to FIG. 8, a flowchart of a process used for handling the notification of a virus based on a business policy is depicted in accordance with a preferred embodiment of the present invention. The process illustrated in FIG. 8 may be implemented in a server, such as server 108 in FIG. 1.

The process begins by receiving a business event (step 800). For example, the business event may be implemented using business event 400 in FIG. 4A. Next the business event is compared to policy (step 802). The policy may take many forms, such as policy 500 in FIG. 5A or policy 502 in FIG. 5B. Then an action is initiated based on the comparison (step 804) with the process terminating thereafter. The initiation of the action may be implemented using a business event, such as business event 412 in FIG. 4B.

Further, the business event is used by the remote administrator to determine additional hardware or software products, such as, for example firewalls, servers or monitoring devices that the customer might need (up-sell) to prevent the occurrence of this type of event in the future. The event is logged and then used as a metric to calculate production efficiency, downtime, failure to adhere to company policies against downloading potentially harmful content or executing harmful programs, and even financial penalties based on the downtime that may be accessed against the user that caused the event, or inadvertently caused the event by ignoring some type of company policy.

Thus, the present invention provides a method, apparatus, and computer implemented instructions for handling viruses and for providing a business service to handle viruses. The mechanism of the present invention sends business events from clients detecting viruses to a server. These business events include an identification of the virus and the action taken to handle the virus in these examples. Further, upon notification of the virus at the server, the server may then perform virus removal processes as well as possibly severing connections to the network to prevent further spreading of the virus. After the virus has been eliminated, server then restores any connections that may have been severed. A further service that may be provided is a determination of what actions to take in response to notification of the presence of a virus. The particular action that is to be taken may depend on various factors, such as, for example, the name of the virus, the type of the virus, the time at which the virus was detected, and the client on which the virus was detected. These actions may include, for example, scheduling maintenance for the server, scheduling maintenance for the client, paging a technician, sending an email message to a network administrator, initiating a voice call to a manager, and instructing the server to shut down. In this manner, the mechanism of the present invention allows for the automatic handling of viruses in a network data processing system without the customer having to take or select actions when viruses are detected.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the remote administrative process is shown as being implemented in a separate computer, server 108, as from the other server processes for locally handling the detection of a virus in server 106, these processes could be implemented in the same computer. The particular implementation illustrates how business services relating to action to be taken with respect to the detection of a virus may be provided from a remote location. The services include deciding what actions to take as well as initiating the actions. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for handling a virus, the method comprising:
monitoring for the virus; and
responsive to detecting the virus, sending a notification of a presence of the virus on the data processing system to a server, wherein the notification includes an identification of an action taken in response to detecting the virus.

2. The method of claim 1, wherein the action is an absence of any action.

3. The method of claim 1, wherein the action is a removal of the virus file in the data processing system.

4. The method of claim 1, wherein the notification includes an identification of the virus.

5. The method of claim 1, wherein the data processing system is a client to the server.

6. A method in a server data processing system for handling a virus, the method comprising:
receiving a notification of a presence of the virus on a client data processing system through a communications link;
severing communication with the client data processing system through the communications link in response to receiving the notification; and
executing virus removal processes on the server data processing system.

7. The method of claim 6 further comprising:
shutting down the server data processing system.

8. The method of claim 6 further comprising:
removing network shares under the control of the server data processing system.

9. The method of claim 6, wherein a set of clients are present and further comprising:
disabling communications links to the set of clients.

10. The method of claim 6 further comprising:
reestablishing communication with the client after virus removal processes have been executed.

11. The method of claim 6 further comprising:
blocking access to a shared resource.

12. The method of claim 11, wherein the shared resource is one of a storage device, an output device, a file, and a drive.

13. A method in a server data processing system for handling a presence of a virus in a network data processing system, the method comprising:
receiving a notification of a presence of the virus on a client data processing system; and
executing an action based on a business policy in response to receiving the notification.

14. The method of claim 13, wherein the action is to execute the virus removal process on the server data processing system.

15. The method of claim 13, wherein the action is at least one of paging a technician, sending a call to a manager, scheduling servers for the client data processing system.

16. The method of claim 13, wherein the policy includes rules identifying actions based on an identification of the client data processing system.

17. The method of claim 13, wherein the policy includes rules identifying actions based on a date on which the notification is received.

18. The method of claim 13, wherein the policy includes rules identifying actions based on a time at which the notification is received.

19. The method of claim 13, wherein the policy includes rules identifying actions based on a function performed by the client data processing system.

20. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to monitor for a virus; and send a notification of a presence of the virus on the data processing system to a server in response to detecting the virus, wherein the notification includes an identification of an action taken in response to detecting the virus.

21. The data processing system of claim 20, wherein the bus system includes a primary bus and a secondary bus.

22. The data processing system of claim 20, wherein the processor unit includes a single processor.

23. The data processing system of claim 20, wherein the processor unit includes a plurality of processors.

24. The data processing system claim 20, wherein the communications unit is an Ethernet adapter.

25. The data processing system of claim 20, wherein the action is an absence of any action.

26. The method of claim 20, wherein the action is a removal of the virus a file in the data processing system.

27. The method of claim 20, wherein the notification includes an identification of the virus.

28. The method of claim 20, wherein the data processing system is a client to the server.

29. A server data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to receive a notification of a presence of a virus on a client data processing system through a communications link; sever communication with the client data processing system through the communications link in response to receiving the notification; and execute virus removal processes on the server data processing system.

30. The server data processing system of claim 29, wherein the processor unit further executes instructions to shut down the server data processing system.

31. The server data processing system of claim 29 wherein the processor unit further executes instructions to remove network shares under the control of the server data processing system.

32. The server data processing system of claim 29, wherein a set of clients are present and wherein the processor unit further executes instructions to disable communications links to the set of clients.

33. The server data processing system of claim 29 wherein the processor unit further executes instructions to reestablish communication with the client after virus removal processes have been executed.

34. The server data processing system of claim 29 wherein the processor unit further executes instructions to block access to a shared resource.

35. The server data processing system of claim 34, wherein the shared resource is one of a storage device, an output device, a file, and a drive.

36. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to receive a notification of a presence of a virus on a client data processing system; and execute an action based on a business policy in response to receiving the notification.

37. The data processing system of claim 36, wherein the action is to execute the virus removal process on the server data processing system.

38. The data processing system of claim 36, wherein the action is at least one of paging a technician, sending a call to a manager, scheduling servers for the client data processing system.

39. The data processing system of claim 36, wherein the policy includes rules identifying actions based on an identification of the client data processing system.

40. The data processing system of claim 36, wherein the policy includes rules identifying actions based on a date on which the notification is received.

41. The data processing system of claim 36, wherein the policy includes rules identifying actions based on a time at which the notification is received.

42. The data processing system of claim 36, wherein the policy includes rules identifying actions based on a function performed by the client data processing system.

43. A data processing system for handling a virus, the data processing system comprising:
monitoring means for monitoring for the virus; and
sending means, responsive to detecting the virus, for sending a notification of a presence of the virus on the data processing system to a server, wherein the notification includes an identification of an action taken in response to detecting the virus.

44. The data processing system of claim 43, wherein the action is an absence of any action.

45. The data processing system of claim 43, wherein the action is a removal of the virus a file in the data processing system.

46. The data processing system of claim 43, wherein the notification includes an identification of the virus.

47. The data processing system of claim 43, wherein the data processing system is a client to the server.

48. A data processing system for handling a virus, the data processing system comprising:
receiving means for receiving a notification of a presence of a virus on a client data processing system through a communications link;
severing means for severing communication with the client data processing system through the communications link in response to receiving the notification; and
executing means for executing virus removal processes on the server data processing system.

49. The data processing system of claim 48 further comprising:
shutting downing means for shutting down the server data processing system.

50. The data processing system of claim 48 further comprising:
removing means for removing network shares under the control of the server data processing system.

51. The data processing system of claim 48, wherein a set of clients are present and further comprising:
disabling means for disabling communications links to the set of clients.

52. The data processing system of claim 48 further comprising:
reestablishing means for reestablishing communication with the client after virus removal processes have been executed.

53. The data processing system of claim 48 further comprising:
blocking means for blocking access to a shared resource.

54. The data processing system of claim 53, wherein the shared resource is one of a storage device, an output device, a file, and a drive.

55. A data processing system for handling a presence of a virus in a network data processing system, the data processing system comprising:
receiving means for receiving a notification of a presence of a virus on a client data processing system; and
executing means for executing an action based on a business policy in response to receiving the notification.

56. The data processing system of claim 55, wherein the action is to execute a virus removal process on the server data processing system.

57. The data processing system of claim 55, wherein the action is at least one of paging a technician, sending a call to a manager, scheduling servers for the client data processing system.

58. The data processing system of claim 55, wherein the policy includes rules identifying actions based on an identification of the client data processing system.

59. The data processing system of claim 55, wherein the policy includes rules identifying actions based on a date on which the notification is received.

60. The data processing system of claim 55, wherein the policy includes rules identifying actions based on a time at which the notification is received.

61. The data processing system of claim 55, wherein the policy includes rules identifying actions based on a function performed by the client data processing system.

62. A computer program product in a computer readable medium for handling a virus, the computer program product comprising:
first instructions for monitoring for the virus; and
second instructions, responsive to detecting the virus, for sending a notification of a presence of the virus on the data processing system to a server, wherein the notification includes an identification of an action taken in response to detecting the virus.

63. A computer program product in a computer readable medium for handling a virus, the computer program product comprising:
first instructions for receiving a notification of a presence of the virus on a client data processing system through a communications link;
second instructions for severing communication with the client data processing system through the communications link in response to receiving the notification; and
third instructions for executing virus removal processes on the server data processing system.

64. A computer program product in a computer readable medium for handling a presence of a virus in a network data processing system, the computer program product comprising:
first instructions for receiving a notification of a presence of the virus on a client data processing system; and
second instructions for executing an action based on a business policy in response to receiving the notification.

65. A method in a data processing system for handling a virus, the method comprising:
monitoring for the virus; and
responsive to detecting the virus, sending a notification of a presence of the virus on the data processing system to a server, wherein the notification includes one of an identification of an action taken and an identification of an action not taken.

66. The method of claim 65, wherein the action includes one of removing the virus from a file, quarantining a file, or removing the file.
